(19) United States
(12) Patent Application Publication
(10) Pub. No.: US 2009/0162014 A1
(43) Pub. Date: Jun. 25, 2009

(54) OPTICAL WAVEGUIDE DEVICE AND OPTICAL APPARATUS USING OPTICAL WAVEGUIDE DEVICE

(75) Inventors: Takashi SHIRAISHI, Kawasaki (JP); Masaharu Doi, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/335,788

(22) Filed: Dec. 16, 2008

(30) Foreign Application Priority Data
Dec. 17, 2007 (JP) 2007-325176

(51) Int. Cl. G02B 6/42

(52) U.S. Cl. 385/45

(57) ABSTRACT

According to an aspect of an embodiment, an optical waveguide; and a branching section which branches a part of a light propagating through the optical waveguide, wherein the branching section has a first coupler which branches the light propagating through the optical waveguide according to a given unequal branching ratio so as to output first and second branched lights, and uses the first branched light as a first output light; and a second coupler which inputs the second branched light output from the first coupler and branches the second branched light into two lights according to a branching ratio which is substantially equal to the branching ratio in the first coupler so as to output third and fourth branched lights, and uses the fourth branched light as a second output light.

### CROSS-REFERENCE TO RELATED APPLICATIONS

This application is related to and claims the benefit of priority from JP2007-325176, filed on Dec. 17, 2007, the entire contents of which are incorporated herein by reference.

### BACKGROUND

1. Field

The invention relates to an optical waveguide device to be used for optical communication. The invention particularly relates to the optical waveguide device that has a coupler for branching a light propagating through an optical waveguide at a required ratio, and to an optical apparatus using the optical waveguide device

2. Description of the Related Art

Waveguide-type optical apparatuses used in optical communication, optical modulators and optical switches are well known. For example, optical modulators, which use an electro-optic crystal such as a lithium niobate (LiNbO₃:LN) substrate, are manufactured in the following manner. A metal film is formed partially on or in an electro-optic crystal substrate, which is thermally diffused or patterned, and then a proton is exchanged in benzoic acid so that an optical waveguide is formed. Thereafter, an electrode is provided along the optical waveguide. In such optical modulators using electro-optical crystals, since an operating point fluctuates due to temperature drift, DC drift or the like, a bias voltage to compensate for the fluctuation is applied to the electrode.

As a conventional technique for controlling this bias voltage, a method described in Japanese Laid-open Patent Publication No. 1991-145623 (Patent Document 1) is publicly known. In this method, an optical detecting section for monitoring is provided at an output side of an optical modulator. The optical detecting section detects radiated lights emitted from a branching section of a Y-branched optical waveguide on the output side in a Mach-Zehnder-type (MZ-type) optical waveguide as monitor lights. Feedback of a bias voltage is controlled based on the detected result. A method in Japanese Patent Application Laid-Open No. 2003-233047 (Patent Document 2) is publicly known. In this method, a 3 dB directional coupler is provided on an output side of an MZ-type optical waveguide, an optical waveguide for monitoring is connected to one of two output ports of the 3 dB directional coupler, an intensity of the monitor lights guided through the optical waveguide for monitoring is detected, and feedback of a bias voltage is controlled based on the detected result.

### SUMMARY

According to an aspect of an embodiment, an optical waveguide; and a branching section which branches a part of a light propagating through the optical waveguide, wherein the branching section has a first coupler which branches the light propagating through the optical waveguide according to a given unequal branching ratio so as to output first and second branched lights, and uses the first branched light as a first output light; and a second coupler which inputs the second branched light outputted from the first coupler and branches the second branched light into two lights according to a branching ratio which is substantially equal to the branching ratio in the first waveguide-type coupler so as to output third and fourth branched lights, and uses the fourth branched light as a second output light, and in the second coupler, wavelength dependence relating to intensity of the second branched light in the first coupler has a characteristic opposite to that of wavelength dependence relating to intensity of the fourth branched light.

### BRIEF DESCRIPTION OF THE DRAWINGS

FIG. 1 is a plan view illustrating a constitution of an optical modulator according to a first embodiment;

FIG. 2 is an enlarged diagram illustrating a specific constitution example of a branching section used in the first embodiment;

FIG. 3 is a diagram illustrating an example of wavelength dependence of a phase difference in an coupler;

FIG. 4 is a diagram illustrating a relationship between output light intensity of the coupler and the phase difference between even and odd modes according to the first embodiment;

FIG. 5 is a diagram illustrating a relationship between a coupling length and the phase difference of the coupler according to the first embodiment;

FIG. 6 is a diagram illustrating a wavelength dependence reducing effect of monitor light intensity by means of the branching section according to the first embodiment;

FIG. 7 is an enlarged diagram illustrating a specific constitution example of the branching section to be used in the optical modulator according to a second embodiment;

FIG. 8 is an enlarged diagram illustrating another constitution example where a width of an interference portion of the coupler is varied in relation to the branching section according to the first embodiment;

FIG. 9 is an enlarged diagram illustrating another constitution example where a gap of the waveguides between an adjacent portion of a directional coupler is varied in relation to the branching section according to the second embodiment;

FIG. 10 is an enlarged diagram illustrating another constitution example where a refraction index of the interference portion of the coupler is varied in relation to the branching section according to the first embodiment;

FIG. 11 is an enlarged diagram illustrating another constitution example where a refraction index of the waveguide in the adjacent portion of the directional coupler is varied in relation to the branching section according to the second embodiment;

FIG. 12 is a plan view illustrating a constitution of the optical modulator according to a third embodiment;

FIG. 13 is an enlarged diagram illustrating a specific constitution example of the branching section used in the third embodiment;

FIG. 14 is a diagram illustrating a relationship between the output light intensity of the coupler and the phase difference between the even and odd modes according to the third embodiment;

FIG. 15 is a diagram illustrating a relationship between the output light intensity and an applied voltage in a conventional optical modulator;

FIG. 16 is a plan view illustrating a constitution example of the optical modulator for extracting a monitor light having the same phase as that of a main signal light;

FIG. 17 is a diagram illustrating an operation outline of the coupler;

FIG. 18 is a diagram illustrating a relationship between the output light intensity and the phase difference between the even and odd modes of the coupler; and

FIG. 19 is a diagram illustrating the wavelength dependence of the intensity of the monitor light in the constitution example in FIG. 16.

### DESCRIPTION OF THE PREFERRED EMBODIMENTS

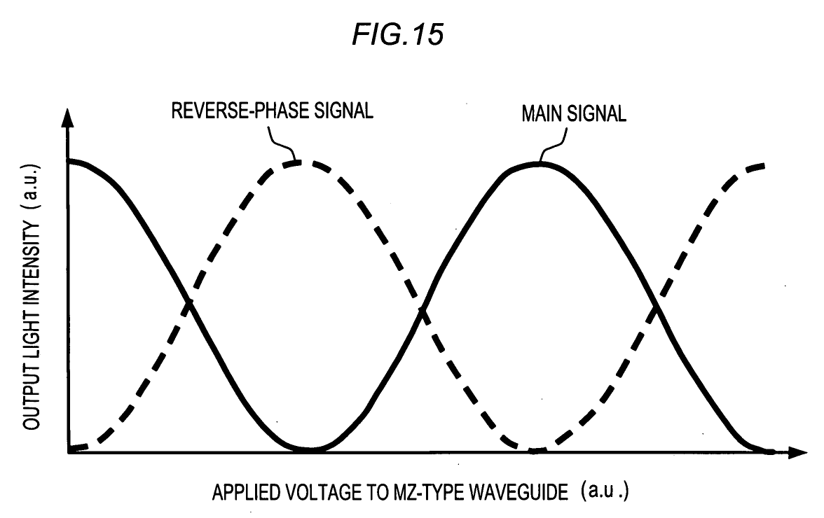

In a technique of controlling a bias voltage in a conventional optical modulator, as explained in FIG. 15, a waveform of a main signal light modulated according to an applied voltage to an electrode (solid line) and a waveform of monitor light (dotted line) hold a relationship of reverse phase. It is difficult for such control using the reverse-phase monitor light to cope with modulating systems that mainly adopt phase modulation, such as a DPSK (Differential Phase Shift Keying) modulating system or a DQPSK (Differential Quadrature Phase Shift Keying) modulating system which are being developed actively in recent years.

That is, for example in the DPSK modulating system, a light is modulated between two values of 0 and π, and the intensity component of the modulated light does not basically change. For this reason, the main signal light is steadily in an emitting state. On the other hand, since the reverse-phase monitor light is always in an extinction state, it is difficult to control the feedback of a bias voltage. Therefore, in order to cope with the modulating system mainly adopting the phase modulation, it is desirable to conduct the control using a monitor light whose phase is the same as or similar to the main signal light.

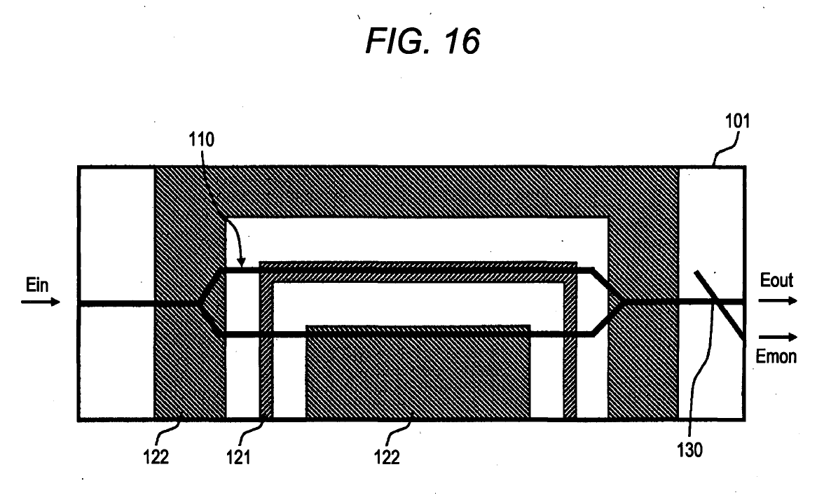

In order to extract the same-phase monitor light, a waveguide coupler 130, as shown in FIG. 16 for example, is formed on or in an output waveguide connected to a Y branch on the output side of an MZ-light optical waveguide 110, and a part of main signal light is extracted by using the waveguide coupler 130. In such a constitution, in order to reduce loss of the main signal light as much as possible, a very small amount of monitor light with respect to the signal light should be extracted. It is preferable to use a coupler that has a branching ratio of 1:10 so that the monitor light amount with respect to the input light amount is −10 dB, or a coupler that has a branching ratio of 1:20 so that the monitor light amount with respect to the input light amount is −20 dB. In this specification, the coupler branching ratios of 1:10 and 1:20 are also called a degree of coupling.

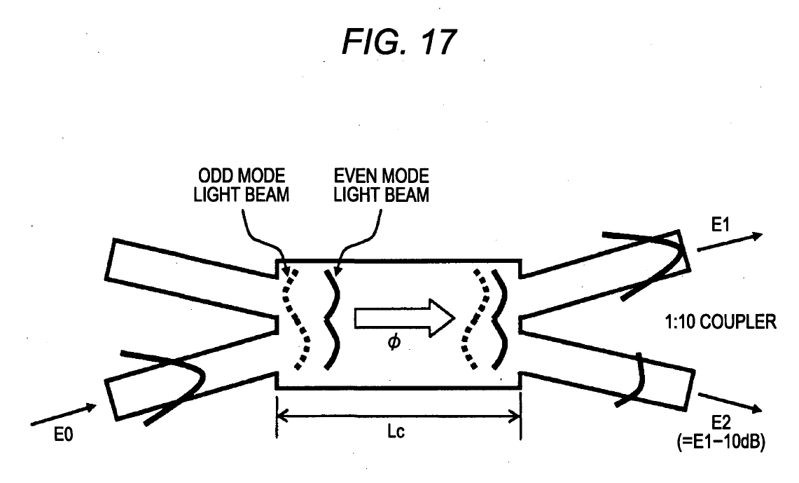

However, when the same-phase monitor light is extracted using the constitution shown in FIG. 16, the intensity of the monitor light changes greatly depending on a wavelength. The wavelength dependence of the same-phase monitor light is described in detail with reference to FIGS. 17 to 19.

FIG. 17 is an outline diagram illustrating a coupler (a multi-mode-interferometer) as a typical waveguide coupler. In this coupler, an incident light E0 which enters from one input waveguide, on the lower left of the drawing, becomes multimode in an interference portion composed of a wide waveguide, and is separated into an even-mode light and an odd-mode light. In the interference portion, since propagation constants of the even-mode light and the odd-mode light are different from each other, the branching ratio of the coupler changes depending on a phase difference between the modes. For example, when the phase difference between the even mode and the odd mode is π/2, the approximately whole input light E0 becomes a light E2 emitted from the output waveguide on the monitor side, in the lower right position in the drawing. On the other hand, when the phase difference between the even mode and the odd mode is π, the approximately whole input light E0 becomes a light E1 emitted from the output waveguide on the main signal side, in the upper right position in the drawing.

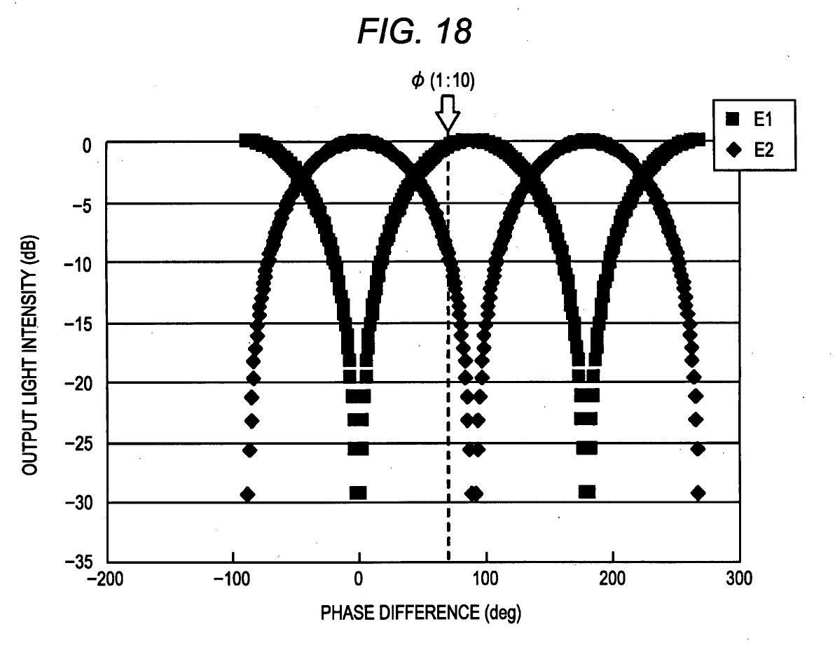

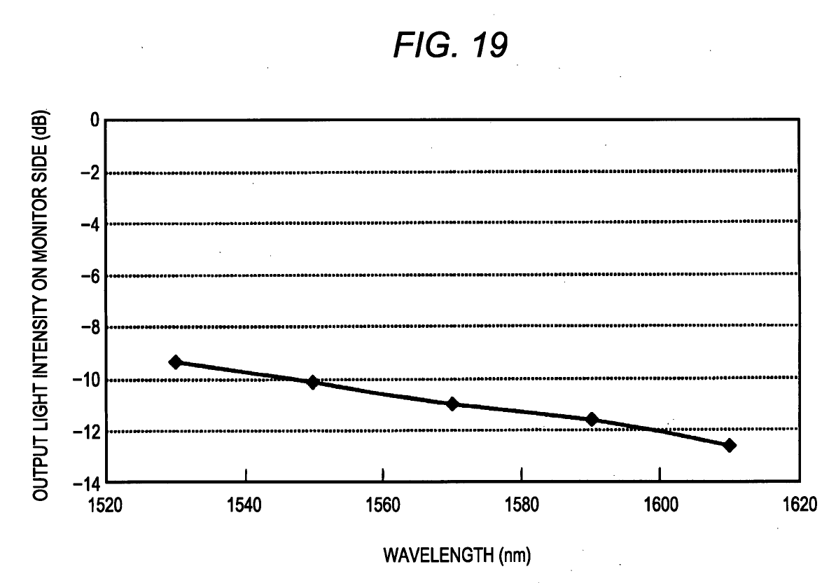

FIG. 18 illustrates an example in which intensity changes of the output light s E1 and E2 corresponding to the output waveguides on the main signal side and the monitor side with respect to the phase difference between the even mode and the odd mode are calculated. An abscissa axis in FIG. 18 represents the phase difference, and an ordinate axis represents the output light intensity with respect to the input light intensity by decibel (dB). In FIG. 18, for example, when the phase difference φ shown by a dashed line is selected, the intensity of the output light e2 on the monitor side with respect to the intensity of the output light E1 on the main signal side becomes −10 dB, so that the coupler whose branching ratio is 1:10 can be realized. In the 1:10 coupler, when the wavelength of the input light E0 changes, the phase difference between the even mode and the odd mode generated on the interference portion changes. According to the change of the phase difference, the intensity of the output light E1 on the main signal side does not change much, whereas the intensity of the output light E2 on the monitor side greatly changes. This is clear from a difference in slopes of curves corresponding to the respective output lights in FIG. 18. That is, the intensity of the output light E2 on the monitor side has large wavelength dependence. FIG. 19 illustrates the wavelength dependence of the output light intensity on the monitor side when the wavelength is plotted along an abscissa axis. In this example, the output light intensity on the monitor side changes by about 3 dB with respect to a change in the wavelength of 1530 nm to 1610 nm.

A large wavelength dependence of the monitor light remarkably reduces the control accuracy of a bias voltage in the optical modulator. Furthermore, such a problem arises not only in the optical modulator, but also may arise similarly in the case where a monitor system is constituted by using a waveguide coupler in various optical apparatuses such as optical switches.

The best mode for carrying out this application will be described below with reference to the accompanying drawings. Like members are designated by like symbols in all the drawings.

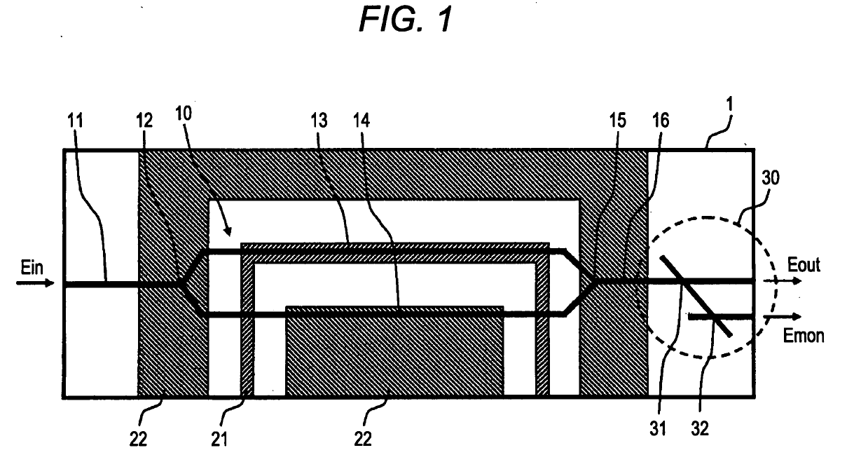

FIG. 1 is a plan view illustrating a constitution of an optical modulator using an optical waveguide device according to a first embodiment.

In FIG. 1, the optical modulator according to the first embodiment includes a substrate 1, an MZ-type optical waveguide section 10, an electrode section including a signal electrode 21 and ground electrodes 22, and a branching section 30. The substrate 1 has an electro-optic effect. The MZ-type optical waveguide section 10 is formed near the surface of the substrate 1. The electrode section is provided along the MZ-type optical waveguide section 10. The branching section 30 is connected to an output waveguide 16 of the MZ-type optical waveguide section 10.

The MZ-type optical waveguide section 10 separates a light Ein inputted into an input waveguide 11 into two lights using a Y-branched waveguide 12 on an input side so as to transmit the two lights to a first arm 13 and a second arm 14, respectively. A Y-branched waveguide 15 on an output side multiplexes the lights propagated through the first and second arms 13 and 14 so as to guide the light to the output waveguide 16.

The electrode section is composed of a signal electrode 21 formed along one arm (the first arm 13) of the MZ-type optical waveguide section 10 on the substrate 1, and a ground electrode 22 separated from the signal electrode 21 by a given distance. A modulation signal and a bias voltage to be outputted from a driving circuit are applied to the signal electrode 21. The constitution example of a one-side drive where the signal electrode 21 is provided on one arm is described below, but a two-side drive constitution where a signal electrode is provided on both arms may be adopted.

The branching section 30 has, for example, first and second waveguide couplers 31 and 32 connected in series. An output light Eout on the main signal side (first output light) is extracted from the waveguide coupler 31 at a preliminary stage, and an output light Emon on the monitor side (second output light) is extracted from the waveguide coupler 32 at a subsequent stage.

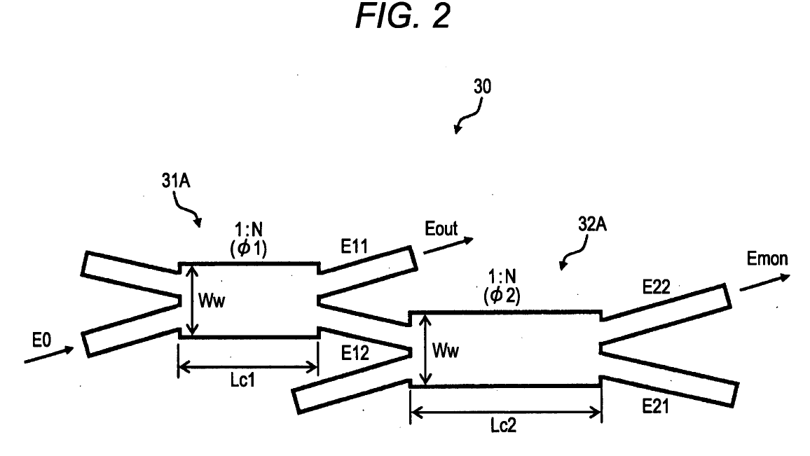

FIG. 2 is an enlarged diagram illustrating a specific constitution example of the branching section 30.

In the constitution example in FIG. 2, multi-mode interferometer (MMI) couplers 31A and 32A apply to the waveguide couplers 31 and 32 at the preliminary and subsequent stages in FIG. 1. The MMI couplers 31 and 32 are designed so that two input waveguides and two output waveguides are optically connected via interference portions composed of wide waveguides and their branching ratios are 1:N (for example, 1:10). Shapes of the interference portions are different between the MMI coupler 31A at the preliminary stage and the MMI coupler 32A at the subsequent stage. In the first embodiment, lengths Lc1 and Lc2 of the interference portions (hereinafter, coupling lengths) along the light advancing direction are set to different values after the wavelength dependence relating to output light intensity, mentioned below, is taken into consideration. Widths of the interference portions of the MMI couplers 31A and 32A at the preliminary stage and the subsequent stage perpendicular to the light advancing direction have the same width Ww.

The light propagating through the output waveguide 16 of the MZ-type optical waveguide section 10 is inputted into one input waveguide of the MMI coupler 31A at the preliminary stage in the branching section 30 using the MMI couplers 31A and 32A. The input light E0 is then branched at 1:N so that branched light E11 on a high intensity side (first branched light) is outputted, as the output light Eout on the main signal side, to the outside of the substrate 1. Branched light E12 on a low intensity side (second branched light) in the coupler 31A at the preliminary stage is inputted into one input waveguide of the coupler 32A at the subsequent stage so as to be branched at 1:N. Branched light E22 on the low intensity side (fourth branched light) is outputted, as the output light beam Emon on the monitor side, to the outside of the substrate 1. Branched light beam E21 on the high intensity side in the coupler 32A at the subsequent stage (third branched light beam) is emitted into the substrate 1.

The wavelength dependence relating to the output light intensity on the main signal side and the monitor side in the branching section 30 will be described in detail.

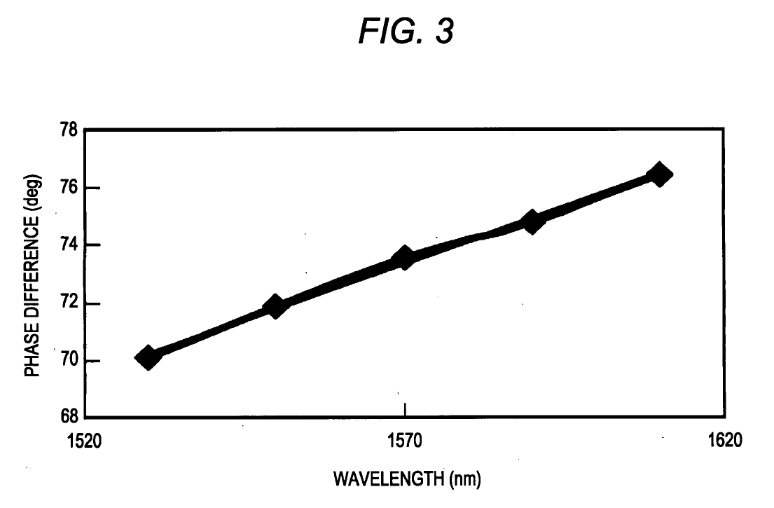

A cause for the wavelength dependence of the output light intensity in the couplers is that the phase difference between the even mode and the odd mode in the interference portions changes depending on the light wavelength. The change in the phase difference depending on the wavelength is caused by a change in an effective refraction index of the waveguides due to the wavelength. For example, as illustrated in FIG. 3, the phase difference tends to be larger as the wavelength is longer.

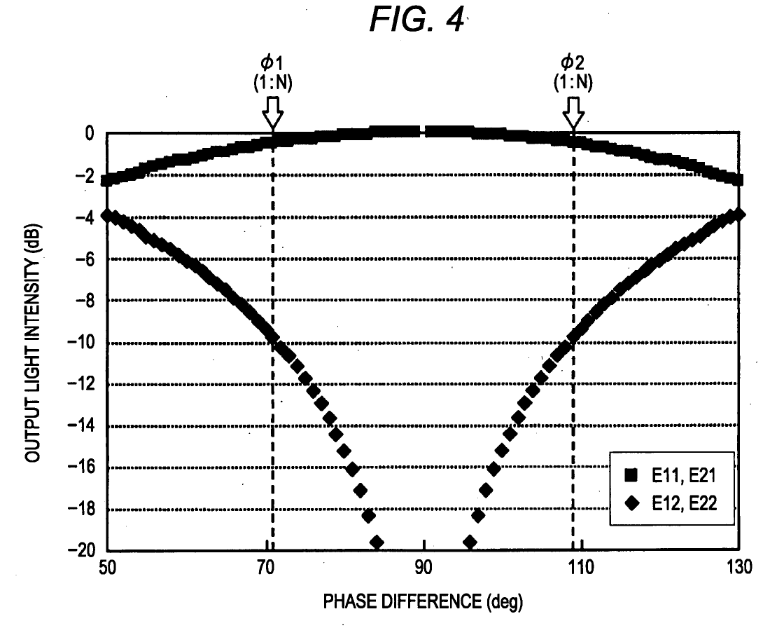

The intensity of the branched light beams E11 and E12 (E21 and E22) outputted from the respective couplers fluctuates as shown in FIG. 4, which is an enlargement of FIG. 18, due to the change in the phase difference depending on the wavelength. For example, when two phase states φ1 and φ2, indicated by arrows and broken lines, are considered, the fluctuation directions of the output light intensity with respect to the change in the phase difference are opposite. That is, in the two phase states φ1 and φ2, the wavelength dependences relating to the output light intensities are opposite. Focusing on the wavelength characteristic, the two phase states φ1 and φ2 are combined so that the wavelength dependence of the output light beam Emon on the monitor side is reduced in an embodiment of the present invention.

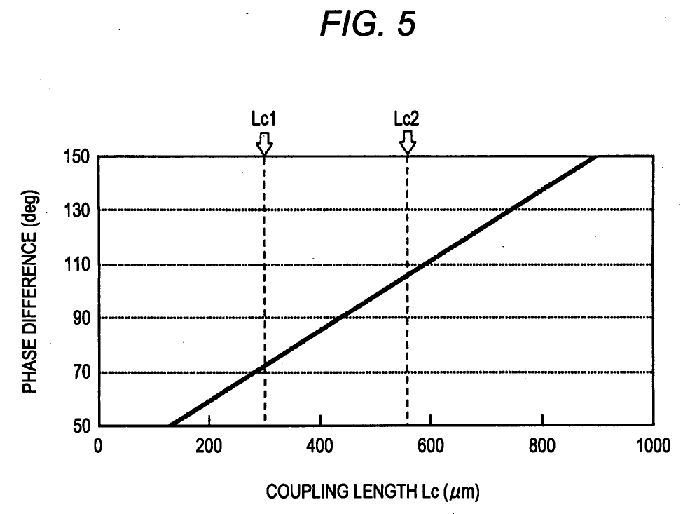

Specifically, in the constitution example of FIG. 2, the coupling lengths Lc1 and Lc2 of the couplers 31A and 32A at the preliminary stage and the subsequent stage are made to be different, so that the two phase states φ1 and φ2 are achieved. As to a relationship between the coupling lengths and the phase difference of the couplers, as illustrated in an example of FIG. 5, since the phase difference becomes larger in proportion to the coupling length, the coupling lengths Lc1 and Lc2 of the couplers 31A and 32A can be designed according to conditions of the waveguides. For example, a Ti layer with a thickness of about 0.1 μm is formed on an LN substrate, and Ti is diffused by a thermal process at 1000° C. for 10 hours to manufacture a waveguide. In this case, Lc1 is set to 300 μm, Lc2 is set to 570 μm, and Ww is set to 18 μm to obtain the two phase states φ1 and φ2 in FIG. 4. This embodiment is not limited to the above specific example.

In the optical modulator having the branching section 30, the light beam Ein inputted into the input waveguide 11 of the MZ-type optical waveguide section 10 is branched into two in the Y-branched waveguide 12 on the input side. The light beams propagate the first and second arms 13 and 14, respectively, and are multiplexed by the Y-branched waveguide 15 on the output side. As a result, the signal light beam whose intensity is modulated according to a modulation signal applied to the signal electrode 21 propagates through the output waveguide 16 so as to be transmitted to the branching section 30.

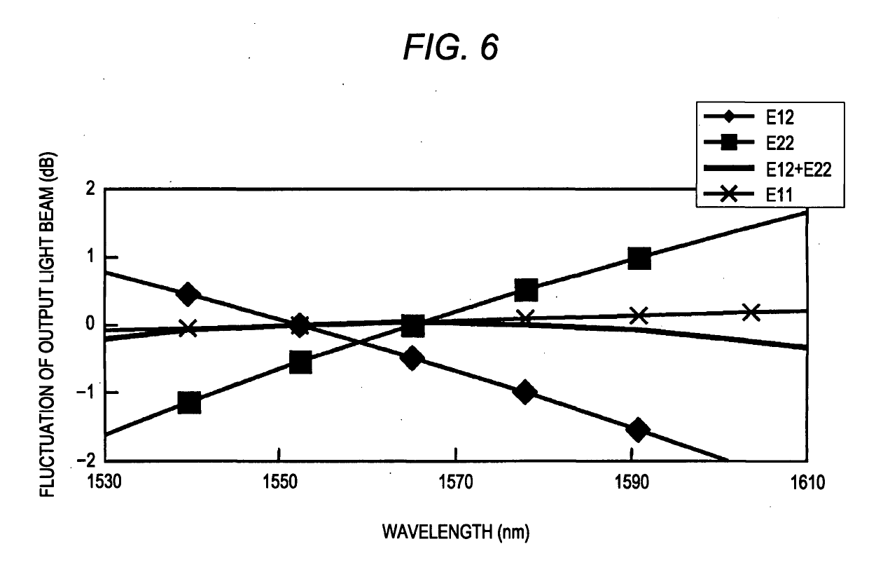

In the branching section 30, the signal light beam from the MZ-type optical waveguide section 10 is inputted into one input waveguide of the coupler 31A at the preliminary stage so as to be transmitted to the interference portion. The phase difference φ1 is given between the even mode and the odd mode on the interference portion of the coupling length Lc1, so that the light beams E11 and E12 branched at the branching ratio of 1:N are each guided to the output waveguides of the coupler 31A at the preliminary stage. At this time, as illustrated in FIG. 6, the intensity of the branched light beam E11 on the high intensity side slightly fluctuates with respect to the change in the wavelength, but the intensity of the branched light beam E12 on the low intensity side is reduced as the wavelength increases. This wavelength dependence will be described below.

The branched light beam E11 on the high intensity side in the coupler 31A at the preliminary stage is outputted as the output light beam Eout on the main signal side to the outside of the substrate 1. On the other hand, the branched light beam E12 on the low intensity side is inputted into one input waveguide of the coupler 32A at the subsequent stage. On the interference portion of the coupling length Lc2, the phase difference φ2 is given between the even mode and the odd mode, so that the light beams E21 and E22 branched according to the branching ratio of 1:N are guided to the output waveguides of the coupler 32A at the subsequent stage. At this time, when a case where the coupler 32A at the subsequent stage is used singularly is assumed, the intensity of the branched light beam E22 on the low intensity side increases according to an increase in the wavelength. This wavelength dependence will be described (see square marks in FIG. 6). For this reason, when the couplers 31A and 32A are connected in series, the branched light beam on the low intensity side in the coupler 32A at the subsequent stage has characteristics obtained by adding the characteristics of E12 and E22. The wavelength dependence at the preliminary stage is cancelled by the wavelength dependence at the subsequent stage (see thick lines in FIG. 6).

According to the optical modulator in the first embodiment, even when a large intensity difference is generated between the main signal light beam and the monitor light beam such that the branching ratio of the couplers is 1:10, the wavelength dependence relating to the output light intensity on the monitor side can be reduced. As a result, satisfactory characteristics (a substantially flat wavelength characteristic) of the monitor light beam Emon in the optical modulator can be obtained. Since a waveform of the monitor light beam Emon has the substantially same phase as that of a waveform of the main signal light beam Eout, this optical modulator can cope with a modulating system based on a phase modulation such as DPSK or DQPSK. Feedback of a bias voltage to be applied to the signal electrode 21 is controlled by a publicly known method using the monitor light beam Emon, so that an operating point drift of the MZ-type optical modulator can be compensated correctly.

A second embodiment will be described below.

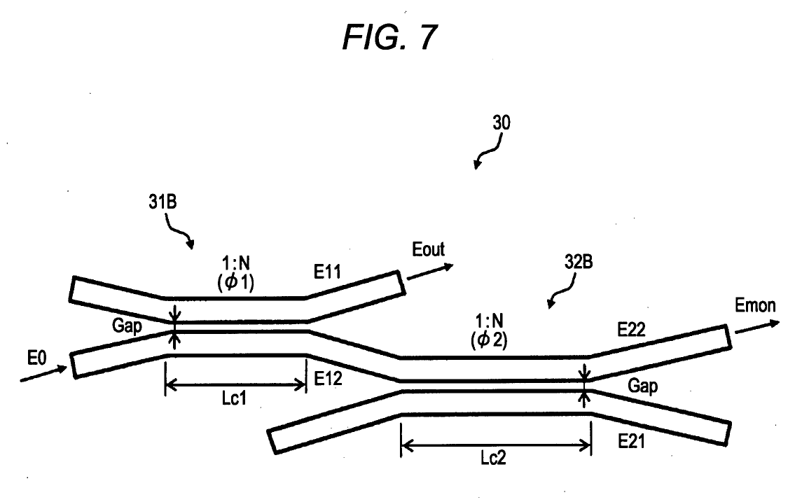

FIG. 7 is an enlarged diagram illustrating a specific constitution example of the branching section 30 according to the second embodiment. Since the entire constitution of the optical modulator is the same as the case of the first embodiment shown in FIG. 1, its illustration and explanation are omitted.

In the constitution example of FIG. 7, waveguide-type directional couplers 31B and 32B are applied as the waveguide-type couplers 31 and 32 at the preliminary stage and the subsequent stage in the branching section 30 in FIG. 1. The directional couplers 31B and 32B are provided with two waveguides together, respectively, and have adjacent portions whose gap between the waveguides on a center portion of the waveguides in a longitudinal direction (light propagating direction) are narrower than that of the other portions. A part of the light beam propagating through one optical waveguide on the adjacent portion is directionally coupled to the other optical waveguide, and the respective branching ratios are 1:N (for example, 1:10) and substantially equal to each other. A difference between the directional coupler 31B at the preliminary stage and the directional coupler 32B at the subsequent stage is that the lengths (hereinafter, coupling lengths) Lc1 and Lc2 of the propagating direction of the light beam on the adjacent portions on the waveguides are set to different values similarly to the case of the couplers after the wavelength dependence relating to the output light intensity is taken into consideration. Gaps between the waveguides on the adjacent portions in both the directional couplers 31B and 32B at the preliminary stage and the subsequent stage have the same value Gap.

In the branching section 30 of FIG. 7, the light beam propagating through the output waveguide 16 of the MZ-type optical waveguide section 10 is inputted into one waveguide (waveguide on a lower position in FIG. 7) of the directional coupler 31B at the preliminary stage. A part of the input light beam E0 is directionally coupled with the other waveguide in the adjacent portion and is branched at 1:N so that the branched light beam E11 on the high intensity side is outputted as the output light beam Eout on the main signal side to the outside of the substrate 1. The branched light beam E12 on the low intensity side in the directional coupler 31B at the preliminary stage is inputted into one waveguide (waveguide on an upper position in FIG. 7) of the directional coupler 32B at the subsequent stage and is branched at 1:N. The branched light beam E22 on the low intensity side is outputted as the output light beam Emon on the monitor side to the outside of the substrate 1. The branched light beam E21 on the high intensity side in the directional coupler 32B at the subsequent stage is emitted into the substrate 1.

The operation of the optical modulator having the branching section 30 using such directional couplers 31B and 32B is the same as the case of the first embodiment, and the coupling lengths Lc1 and Lc2 of the adjacent portions of the directional couplers 31B and 32B at the preliminary stage and the subsequent stage are made to be different. As a result, the two phase states φ1 and φ2 shown in FIG. 4 are realized, and the wavelength dependence relating to the output light intensity in the directional coupler 31B at the preliminary stage is cancelled by the wavelength dependence relating to the output light intensity in the directional coupler 32B at the subsequent stage. As a result, even when the branching ratio is 1:10, for example, a great intensity difference is generated between the main signal light beam and the monitor light beam, the wavelength dependence relating to the output intensity on the monitor side can be reduced. As a result, satisfactory characteristics (a substantially flat wavelength characteristic) of the monitor light beam Emon in the optical modulator can be obtained.

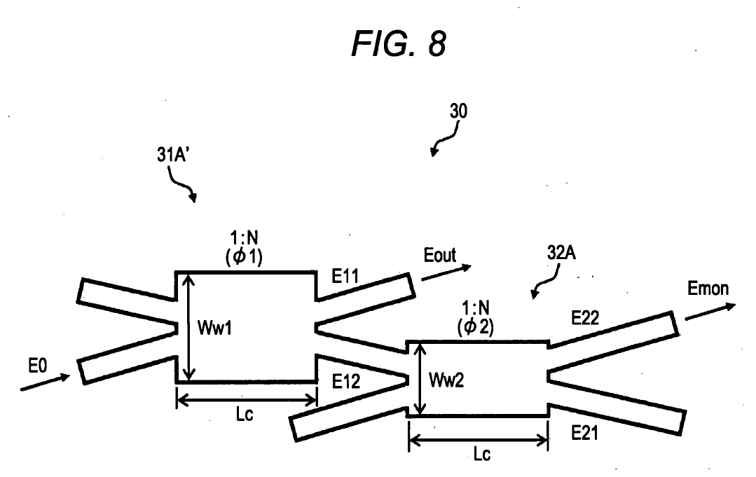

In the first and second embodiments, the coupling wavelengths Lc1 and Lc2 of the interference portions in the couplers 31A and 32A or the coupling lengths Lc1 and Lc2 of the adjacent portions in the directional couplers 31B and 32B are made to be different, so that the two phase states φ1 and φ2 corresponding to the branching ratio 1:N are realized in the branching section 30. For example as illustrated in FIG. 8, the coupling lengths of the interference portions of the couplers at the preliminary stage and the subsequent stage have the same value Lc, and the widths of the interference portions at the preliminary stage and the subsequent stage may be made to be different.

Specifically in the constitution example of FIG. 8, the width Ww1 of the interference portion of the coupler 31A′ at the preliminary stage is wider than the width Ww2 of the interference portion of the coupler 32A′ at the subsequent stage. When the width of the interference portion is made to be comparatively wide, the phase change amount on the interference portion becomes small even when the coupling lengths are substantially equal. Since this corresponds to the case where the coupling length is short, the two phase states φ1 and φ2 shown in FIG. 4 are realized.

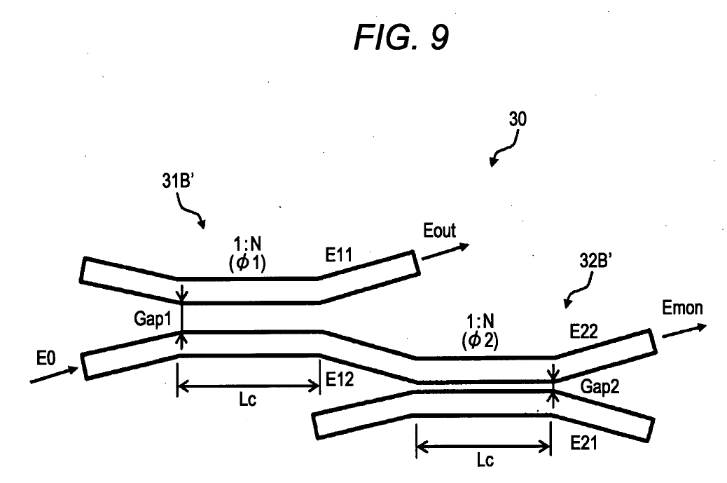

A constitution similar to that in FIG. 8 can be applied also to the directional couplers, and for example as illustrated in FIG. 9, the coupling lengths of the adjacent portions of the directional couplers 31B′ and 32B′ have the same value Lc. A gap Gap[ ]1 between the waveguides on the adjacent portion of the directional coupler 31B′ at the preliminary stage is made to be wider than a gap Gap[ ]2 between the waveguides on the adjacent portion of the directional couplers 32B′ at the subsequent stage. As a result, two phase states φ1 and φ2 may be realized.

When the couplers 31A′ and 32A′ or the directional couplers 31B′ and 32B′ are applied to the branching section 30, the length of the branching section 30 in the light advancing direction becomes short. For this reason, miniaturization of the optical modulator can be realized.

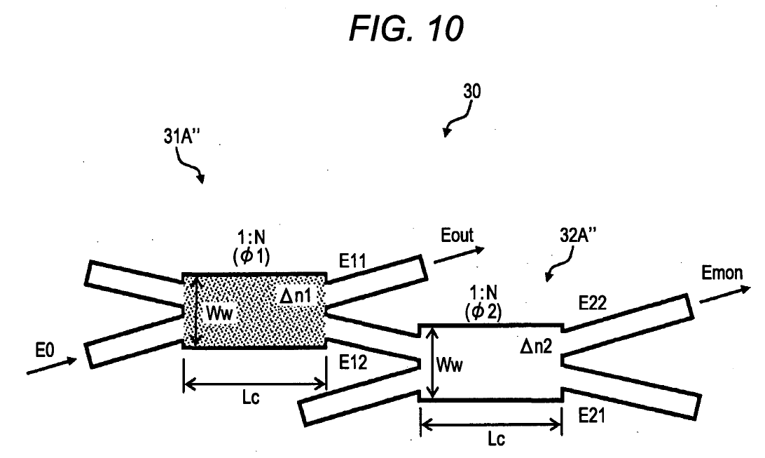

As illustrated in FIG. 10 for example, the interference portions of the couplers 31A″ and 32A″ at the preliminary stage and the subsequent stage may have the same shape (coupling length is Lc and width is Ww), while the refraction indexes of the interference portions at the preliminary stage and the subsequent stage can be different. Specifically, a refraction index Δn1 of the interference portion of the coupler 31A″ at the preliminary stage is made to be larger than a refraction index Δn2 of the interference portion of the coupler 32A″ at the subsequent stage. As a result, even if their coupling lengths and widths are the same as each other, the phase change amount of the interference portions becomes small. Since this corresponds to a case where the coupling length is short, the two phase states φ1 and φ2 shown in FIG. 4 are realized.

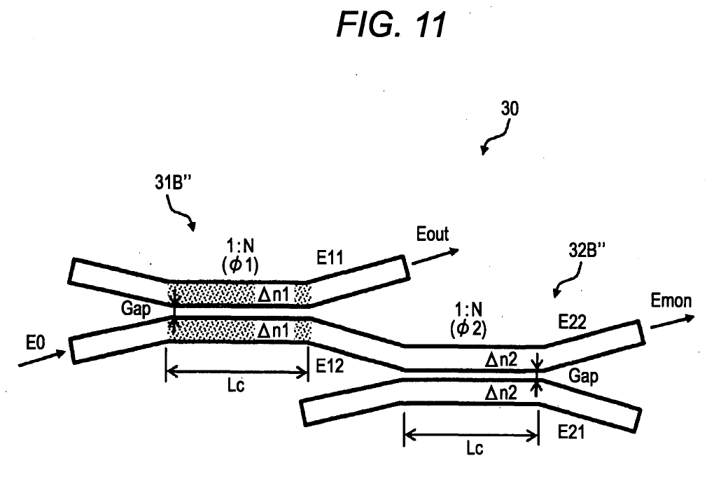

The constitution similar to that in FIG. 10 can be applied also to the directional couplers. For example as illustrated in FIG. 11, the shapes of the adjacent portions of the directional couplers 31B″ and 32B″ are substantially the same as each other (the coupling lengths are Lc and the gap between the waveguides is Gap), and the refraction index Δn1 of the waveguides on the adjacent portion of the directional coupler 31B″ at the preliminary stage is made to be larger than the refractive index Δn2 of the waveguides on the adjacent portion of the directional coupler 32B″ at the subsequent stage. As a result, two phase states φ1 and φ2 may be realized.

When the couplers 31A″ and 32A″ or the directional couplers 31B″ and 32B″ are applied to the branching section 30, a waveguide pattern can be shared by the couplers at the preliminary stage and the subsequent stage. For this reason, the pattern of the branching section 30 can be designed easily.

A third embodiment will be described below.

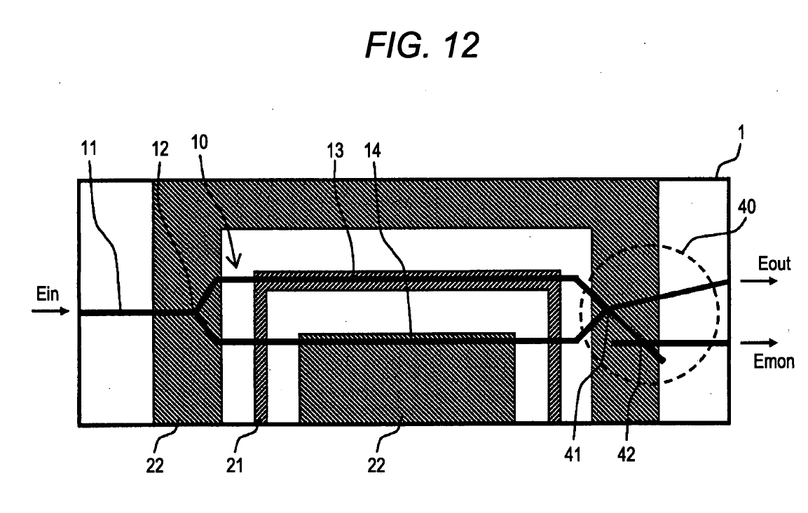

FIG. 12 is a plan view illustrating a constitution of the optical modulator using the optical waveguide device according to the third embodiment.

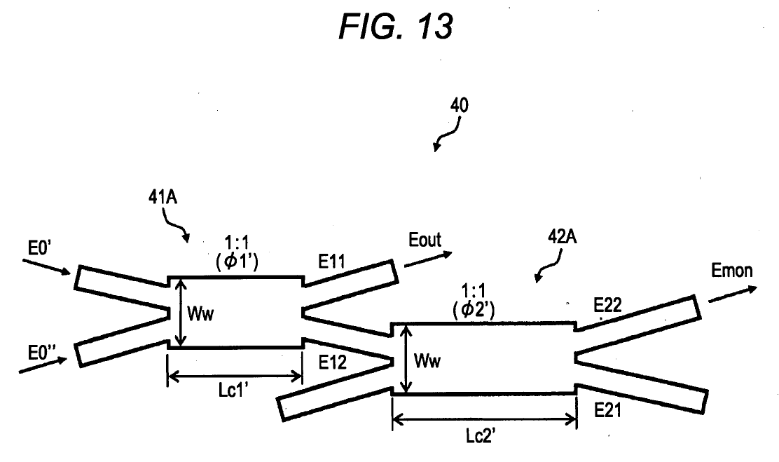

In FIG. 12, a difference between this constitution of the optical modulator and the constitution in the first embodiment (FIG. 1) is that the portions corresponding to the Y-branched waveguide 15 and the output waveguide 16 on the output side in the MZ-type optical waveguide section 10 are composed of a waveguide-type coupler 41 at the preliminary stage of the branching section 40. In the branching section 40, as illustrated in the enlarged diagram of FIG. 13 for example, couplers 41A and 42A having a branching ratio of 1:1 are used as the waveguide-type couplers 41 and 42 at the preliminary stage and the subsequent stage. The couplers 41A ad 42A may use MMI coupler. Coupling lengths Lc1′ and Lc2′ of the interference portions of the couplers 41A ad 42A are set to different values after the wavelength dependence relating to the output light intensity is taken into consideration as in the first embodiment.

In the branching section 40 in FIG. 13, a light beam E0′ which has propagated through the first arm 13 of the MZ-type optical waveguide section 10 is inputted into one input waveguide of the coupler 41A at the preliminary stage, and a light beam E0″ which has propagated through the second arm 14 of the MZ-type optical waveguide section 10 is inputted into the other input waveguide of the coupler 41A at the preliminary stage. After the light beams E0′ and E0″ inputted into the coupler 41A at the preliminary stage propagate through the interference portion and become multiplexed, the multiplexed light beam is branched into two light beams at 1:1. One branched light beam E11 is outputted as the output light beam Eout on the main signal side to the outside of the substrate 1. The other branched light beam E12 is sent to the coupler 42A at the subsequent stage. In the coupler 42A at the subsequent stage, the input light beam E12 is further branched into two light beams at 1:1, one branched light beam E22 is outputted as the output light beam Emon on the monitor side to the outside of the substrate 1, and the other light beam E21 is emitted into the substrate 1.

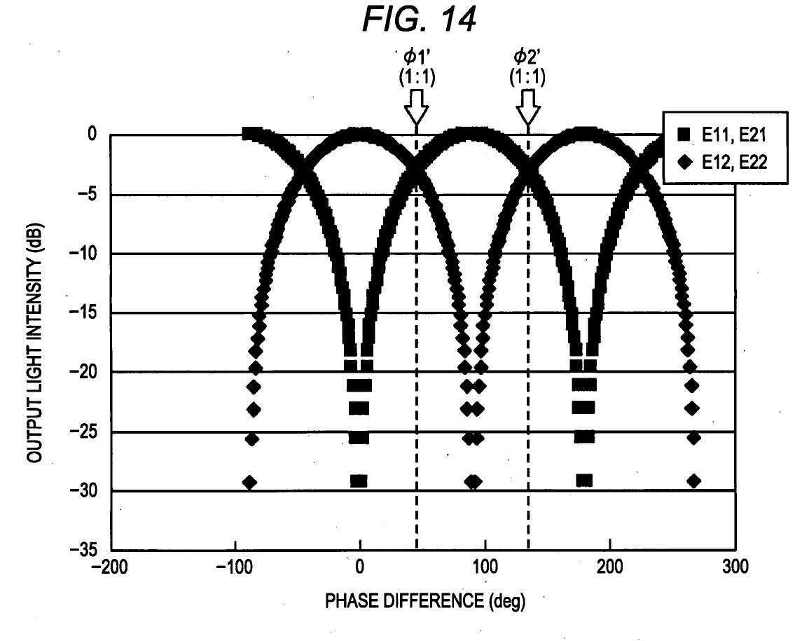

In the optical modulator having such a constitution, the waveform of the monitor light beam Emon outputted from the coupler 42A at the subsequent stage in the branching section 40 has a phase opposite the waveform of the main signal light beam Eout outputted from the coupler 41A at the preliminary stage. For this reason, it is difficult for this optical modulator to cope with the modulating system based on the phase modulation such as DPSK or DQPSK. But if the optical modulator adopting the intensity modulating system, when the wavelength dependence relating to the monitor light intensity becomes a problem, it is effective to apply the constitution of the third embodiment to the modulator. That is, the coupling lengths Lc1′ and Lc2′ of the interference portions of the couplers 41A and 42A at the preliminary stage and the subsequent stage in the branching section 40 are made to be different, so that the two phase states φ1′ and φ2′ indicated by arrows and broken lines in FIG. 14, for example, are realized. Since the wavelength dependence relating to the output light intensity in the coupler 41A at the preliminary stage is cancelled by the wavelength dependence relating to the output light intensity in the coupler 42A at the subsequent stage, satisfactory characteristics (a substantially flat wavelength characteristic) of the monitor light beam Emon in the optical modulator can be obtained.

The third embodiment described the constitution example where the couplers are used as the waveguide-type couplers at the preliminary stage and the subsequent stage in the branching section 40, but the directional couplers shown in FIG. 7 may be used to compose the waveguide-type couplers at the preliminary stage and the subsequent stage. Similar to the cases of FIGS. 8 to 11, the widths or the refraction indexes (or the gaps between waveguides on the adjacent portions or refraction indexes of the waveguides of the directional couplers at the preliminary stage and the subsequent stage) of the interference portions of the couplers at the preliminary stage and the subsequent stage are made to be different. As a result, the two phase states φ1′ and φ2′ shown in FIG. 14 can be realized.

The first to third embodiments described cases where the branching sections 30 and 40 are used as the monitoring systems of the MZ-type optical modulator, but the optical apparatus to which the optical waveguide device (branching section) of this application is applied is not limited to the MZ-type optical modulator. For example, the optical waveguide device of this application may be effective as a monitor system which monitors the intensity of the output light beam via a waveguide optical switch so as to control a switching operation. Furthermore, the optical waveguide device of this application is effective not only for the application as a monitor system for main signal light beam, but also for various applications whose object is to branch a part of an input light beam using the waveguide type branching coupler to extract a plurality of output light beams. Various applications in optical apparatuses for the optical waveguide device can be suitably determined.

The above embodiment includes the following configuration.

An optical waveguide device comprising:
a substrate;
a waveguide on or in the substrate;
a first branching unit for branching input light into first light and second light, wherein a power of the first light is higher than a power of the second light;
a second branching unit, optically coupled to the first branching unit by the second light, for branching the second light into third light and fourth light, wherein a power of third branched light is higher than a power of the fourth light; and
a monitor port, optically couple to the second branching unit, for outputting monitor light for the first light as the forth light.

What is claimed is:

1. An optical waveguide device comprising:
an optical waveguide; and
a branching section which branches a part of a light propagating through the optical waveguide,
wherein the branching section has a first coupler which branches the light propagating through the optical waveguide according to a given unequal branching ratio so as to output first and second branched lights, and uses the first branched light as a first output light; and a second coupler which inputs the second branched light outputted from the first coupler and branches the second branched light into two lights according to a branching ratio which is substantially equal to the branching ratio in the first coupler so as to output third and fourth branched lights, and uses the fourth branched light as a second output light, and
in the second coupler, wavelength dependence relating to intensity of the second branched light in the first coupler has a characteristic opposite to that of wavelength dependence relating to intensity of the fourth branched light.

2. The optical waveguide device according to claim 1, wherein the first and second couplers are couplers whose two input waveguides and two output waveguides are optically connected, respectively, via interference portions composed of wide waveguides.

3. The optical waveguide device according to claim 2, wherein the interference portions of the first and second couplers have different coupling lengths.

4. The optical waveguide device according to claim 2, wherein the interference portions of the first and second couplers have different widths.

5. The optical waveguide device according to claim 2, wherein the interference portions of the first and second couplers have different refraction indexes.

6. The optical waveguide device according to claim 1, wherein the first and second couplers are directional couplers which have an adjacent portion where two optical waveguides are installed together and a gap between the waveguides at a center portion of the optical waveguides in a longitudinal direction is narrower than the other portion.

7. The optical waveguide device according to claim 6, wherein the adjacent portions of the first and second couplers have different coupling lengths.

8. The optical waveguide device according to claim 6, wherein the adjacent portions of the first and second couplers have different gaps between the waveguides.

9. The optical waveguide device according to claim 6, wherein the adjacent portions of the first and second couplers have different refraction indexes.

10. The optical waveguide device according to claim 1, comprising a waveguide type optical modulator.

11. The optical waveguide device according to claim 10, wherein
the optical modulator has a substrate having an electro-optic effect, a Mach-Zehnder-type optical waveguide section which is formed on or in the substrate, and an electrode section which is formed along the Mach-Zehnder-type optical waveguide section; and a light to be inputted into the Mach-Zehnder-type optical waveguide section is modulated according to an electric signal applied to the electrode section so as to be outputted, and
the optical waveguide device is connected to an output end of the Mach-Zehnder-type optical waveguide section, the first output light is outputted as a main signal light to the outside of the substrate, and the second output light is outputted as a monitor light to the outside of the substrate.

12. The optical waveguide device according to claim 11, wherein
the Mach-Zehnder-type optical waveguide section has an input waveguide to which a light is inputted, a Y-branched waveguide on an input side which branches the light propagating through the input waveguide into two, a first arm and a second arm to which the lights branched by the Y-branched waveguide on the input side are given, respectively, a Y-branched waveguide on an output side which multiplexes the lights propagating through the first and second arms, and an output waveguide to which the light multiplexed by the Y-branched waveguide on the output side is given, and
in the optical waveguide device, the light outputted from the output waveguide of the Mach-Zehnder-type optical waveguide section is inputted into the first coupler, and the main signal light and the monitor light have substantially the same phase.

13. The optical waveguide device according to claim 11, wherein
the Mach-Zehnder-type optical waveguide section has an input waveguide to which a light is inputted, a Y-branched waveguide on an input side which branches the light propagating through the input waveguide into two, and a first arm and a second arm to which the lights branched by the Y-branched waveguide on the input side are given, respectively, and
in the optical waveguide device, the lights which propagate through the first and second arms of the Mach-Zehnder-type optical waveguide section are inputted into the first coupler, and the main signal light and the monitor light have reversed phases.

14. The optical waveguide device according to claim 9, comprising a waveguide type optical switch.

15. An optical waveguide device comprising:
a substrate;
a waveguide on or in the substrate;
a first branching unit for branching input light into first light and second light, wherein a power of the first light is higher than a power of the second light;
a second branching unit, optically coupled to the first branching unit by the second light, for branching the second light into a third light and a fourth light, wherein a power of the third branched light is higher than a power of the fourth light; and
a monitor port, optically coupled to the second branching unit, for outputting the fourth light as monitor light for the first light.

16. The optical waveguide device according to claim 15,
wherein the substrate has an electro-optic effect.

17. The optical waveguide device according to claim 15,
wherein the monitor port outputs the monitor light which has a substantially flat wavelength characteristic.

18. The optical waveguide device according to claim 15,
wherein each of the first and second branching units is a multi-mode-interferometer.

19. The optical waveguide device according to claim 15,
wherein each of the first and second branching units has a wavelength dependence with respect to an intensity of the monitor light.
